(19) United States
(12) Patent Application Publication
(10) Pub. No.: US 2025/0316973 A1
(43) Pub. Date: Oct. 9, 2025

(54) OVERCURRENT PROTECTION CIRCUIT USED WITH CHARGE PUMP AND THE CONTROL METHOD THEREOF

(71) Applicant: Hangzhou Silicon-Magic Semiconductor Technology Co.,Ltd, Hangzhou (CN)

(72) Inventors: Zhibin BAI, Hangzhou (CN); Haibo ZHANG, Hangzhou (CN)

(73) Assignee: Hangzhou Silicon-Magic Semiconductor Technology Co.,Ltd, Hangzhou (CN)

(21) Appl. No.: 19/093,289

(22) Filed: Mar. 28, 2025

(30) Foreign Application Priority Data
Apr. 3, 2024 (CN) 2024104052102
May 7, 2024 (CN) 2024105545681

(51) Int. Cl. H02H 3/08; H02M 3/07

(52) U.S. Cl. CPC H02H 3/08; H02M 3/07

(57) ABSTRACT

A charge pump having a first capacitor, a current controlling transistor and an overcurrent protection circuit. The first capacitor has a first terminal and a second terminal. The current controlling transistor has a first terminal coupled to the first terminal of the first capacitor, and a second terminal coupled to a ground reference. The overcurrent protection circuit has a current source and a bias transistor. The current source has a first terminal coupled to a power supply. The bias transistor has a first terminal coupled to a second terminal of the current source, a second terminal coupled to the ground reference, and a control terminal coupled to both the first terminal of the bias transistor and a control terminal of the current controlling transistor.

### CROSS-REFERENCE TO RELATED APPLICATION

This application claims the benefit of Chinese patent application No. 202410405210.2, filed on Apr. 3, 2024, and Chinese patent application No. 202410554568.1, filed on May. 7, 2024, which are incorporated herein by reference in its entirety.

### TECHNICAL FIELD

The present disclosure relates to semiconductor technology, and in particular, to a protection circuit used with a charge pump and the control method thereof.

### BACKGROUND

A voltage charge pump is a direct current to direct current (DC-DC) voltage converter that operates to convert an input voltage into an output voltage under another voltage condition. In many cases, an input is a power supply voltage of a circuit. Such charge pump circuits typically use a capacitor as an energy storage device. The capacitor is switched when a required voltage conversion occurs. However, when a short circuit occurs in the capacitor, a relatively large current is generated, posing a risk of damage damaging a power switch in a circuit.

### SUMMARY

It is an objective of the present disclosure to provide a charge pump and an overcurrent protection circuit used with the charge pump.

The embodiments of the present invention are directed to a charge pump includes a first capacitor, a current controlling transistor, an overcurrent protection circuit. The first capacitor has a first terminal and a second terminal. The current controlling transistor has a first terminal, a second terminal and a control terminal. The first terminal is coupled to the first terminal of the first capacitor, and the second terminal is coupled to a ground reference. The overcurrent protection circuit includes a current source and a bias transistor. The current source has a first terminal, a second terminal and a control terminal, wherein the first terminal is coupled to a power supply. The bias transistor has a first terminal, a second terminal and a control terminal, wherein the first terminal is coupled to the second terminal of the current source, the second terminal is coupled to the ground reference, and the control terminal is coupled to both the first terminal of the bias transistor and the control terminal of the current controlling transistor.

The embodiments of the present invention are directed to an overcurrent protection circuit used with a charge pump. The charge pump includes a first capacitor and a current controlling transistor coupled between a first terminal of the capacitor and a ground reference. The overcurrent protection circuit includes a current source and a bias transistor. The current source has a first terminal, a second terminal and a control terminal, wherein the first terminal is coupled to a power supply, and the control terminal is in response to a voltage at the terminal of the capacitor. The bias transistor has a first terminal, a second terminal and a control terminal, wherein the first terminal is coupled to the second terminal of the current source, the second terminal is coupled to the ground reference, and the control terminal is coupled to both the first terminal of the bias transistor and a control terminal of the current controlling transistor.

The embodiments of the present invention are directed to a control method of an overcurrent protection circuit used with a charge pump. The control method includes actions of generating a current controlling signal based on a voltage at a terminal of a capacitor of the charge pump; generating a current flowing through a bias transistor based on the current controlling signal; mirroring the current flowing through the bias transistor to a current controlling transistor coupled between the terminal of the capacitor and a ground reference.

### BRIEF DESCRIPTION OF THE DRAWINGS

The present disclosure can be further understood with reference to following detailed description and appended drawings, wherein like elements are provided with like reference numerals. These drawings are only for illustration purpose, thus may only show part of the devices and are not necessarily drawn to scale. It is obvious that the drawings described below are some implementations of the present disclosure, and those skilled in the art would also obtain other drawings on the basis of these drawings, without involving any inventive skill.

FIG. 1 schematically shows an overcurrent protection circuit used with a charge pump in accordance with an embodiment of the present disclosure.

FIG. 2 schematically shows an overcurrent protection circuit used with a charge pump in accordance with an embodiment of the present disclosure.

FIG. 3 schematically shows an overcurrent protection circuit used with a charge pump in accordance with an embodiment of the present disclosure.

FIG. 4 schematically shows a saturation characteristic curve of a field-effect transistor.

FIG. 5 schematically shows an overcurrent protection circuit used with a charge pump in accordance with an embodiment of the present disclosure.

FIG. 6 schematically shows a voltage-current characteristic curve in accordance with an embodiment of the present disclosure.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid obscuring aspects of the present disclosure.

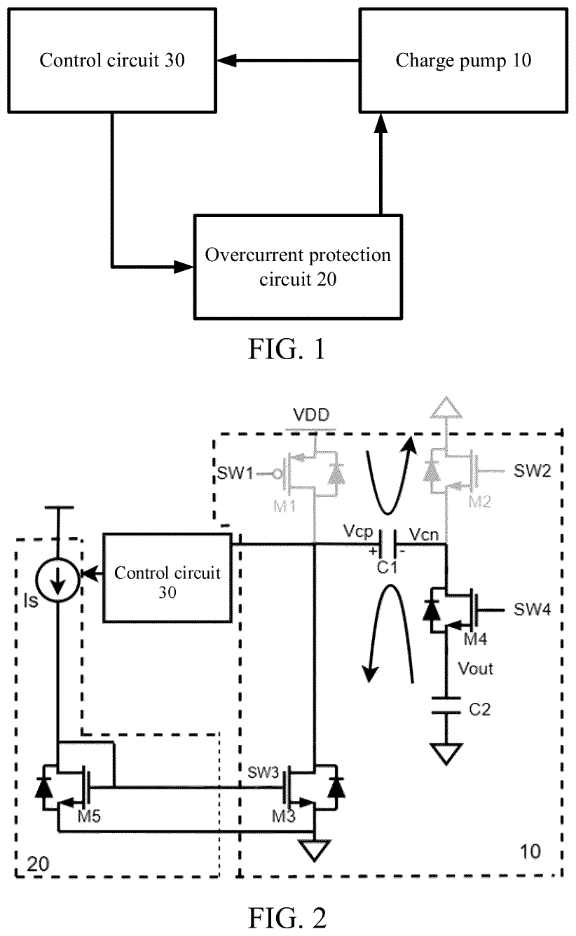

FIG. 1 schematically shows an overcurrent protection circuit used with a charge pump in accordance with an embodiment of the present disclosure. The overcurrent protection circuit includes a charge pump 10, an overcurrent protection circuit 20, and a control circuit 30. The control circuit 30 is connected to the charge pump 10 and the overcurrent protection circuit 20. The control circuit 30 controls, based on a comparison voltage of the charge pump 10, a control voltage outputted from the overcurrent protection circuit 20 to the charge pump 10.

In an embodiment, the comparison voltage is generated through the charge pump 10. The comparison voltage is inputted to the control circuit 30. A corresponding level is outputted through the control circuit 30 based on the comparison voltage, to control the overcurrent protection circuit 20. The overcurrent protection circuit 20 controls, based on the corresponding level outputted through the control circuit 30, the control voltage outputted to the charge pump 10.

FIG. 2 schematically shows an overcurrent protection circuit used with a charge pump in accordance with an embodiment of the present disclosure. The charge pump 10 includes a first transistor M1, a second transistor M2, a first capacitor C1, a third transistor M3 (also referred as a current controlling transistor), a fourth transistor M4, and a second capacitor C2. A first terminal of the first capacitor C1 is connected to a first terminal of the first transistor M1, and a second terminal thereof is connected to a first terminal of the second transistor M2. A first terminal of the third transistor M3 is connected to the first terminal of the first capacitor C1, and a second terminal thereof is grounded. A first terminal of the fourth transistor M4 is connected to a second terminal of the first capacitor C1. A first terminal of the second capacitor C2 is connected to a second terminal of the fourth transistor M4. A second terminal of the first transistor M1 is connected to a power supply VDD, and a second terminal of the second transistor M2 is grounded.

During an operation of the charge pump 10, when the first transistor M1 and the second transistor M2 are turned on and the third transistor M3 and the fourth transistor M4 are turned off, the first capacitor C1 is charged by the power supply VDD. When the first transistor M1 and the second transistor M2 are turned off and the third transistor M3 and the fourth transistor M4 are turned on, the second capacitor C2 is charged by the first capacitor C1. During the charging of the second capacitor C2 by the first capacitor C1, a voltage difference between the two capacitors gradually decreases until the voltage difference approaches zero, in which case the first capacitor C1 and the second capacitor C2 achieve voltage equalization, thereby completing the charging of the second capacitor C2 by the first capacitor C1. In an embodiment, an output voltage Vout of the second capacitor C2 is a negative voltage.

The overcurrent protection circuit 20 includes a current source Is and a fifth transistor M5 (also referred as a bias transistor). The current source Is is connected to the control circuit 30. The fifth transistor M5 is connected to the current source Is and the third transistor M3. The current source Is, the fifth transistor M5, and the third transistor M3 form a current mirror circuit. During the operation of the charge pump 10, if an unexpected short circuit occurs in the second capacitor C2, a current in the circuit increases, which causes the third transistor M3 and the fourth transistor M4 to be damaged. In an embodiment, the overcurrent protection circuit 20 may form the current mirror circuit through connection of the fifth transistor M5 to the third transistor M3. When a short circuit occurs in the second capacitor C2, a voltage at the first terminal of the first capacitor C1 increases, causing the third transistor M3 to enter a saturation region. In this case, the current is controlled by a power supply of the current source Is, to prevent the third transistor M3 and the fourth transistor M4 from being damaged due to an excessively large current flowing therethrough when the second capacitor C2 is short-circuited.

An input terminal of the control circuit 30 is connected to the charge pump 10, and an output terminal thereof is connected to the overcurrent protection circuit 20. The control circuit 30 may control, based on a comparison voltage of the charge pump 10, a control voltage outputted from the overcurrent protection circuit 20 to the charge pump 10. In an embodiment, the comparison voltage is the voltage at the first terminal of the first capacitor C1. Since the fourth transistor M4 operates in a linear region and has a very small voltage difference, the comparison voltage is actually equivalent to a voltage difference between the first capacitor C1 and the second capacitor C2. In an embodiment, the control voltage of the charge pump 10 is a gate driving voltage of the third transistor M3.

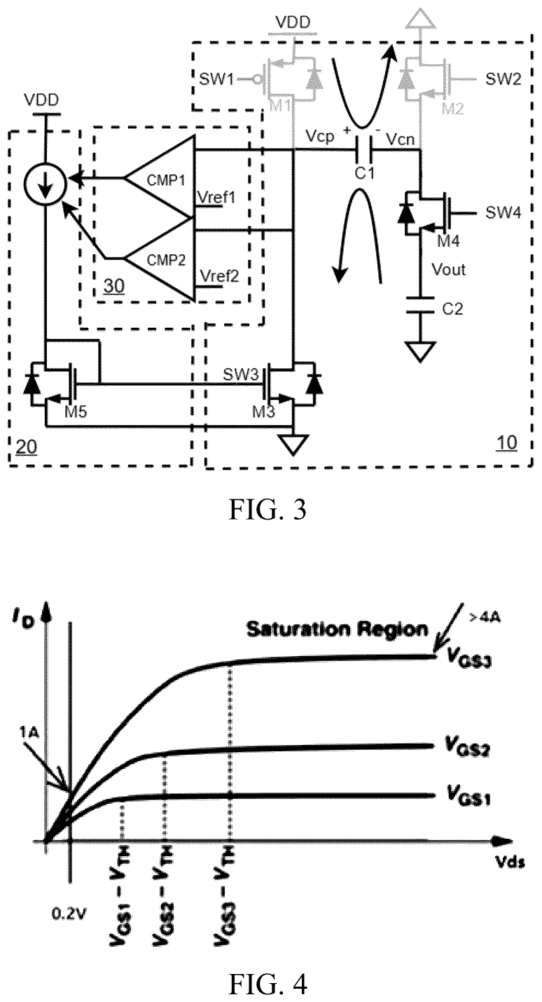

FIG. 3 schematically shows an overcurrent protection circuit used with a charge pump in accordance with an embodiment of the present disclosure. The charge pump 10 includes a first transistor M1, a second transistor M2, a first capacitor C1, a third transistor M3, a fourth transistor M4, and a second capacitor C2. A first terminal of the first capacitor C1 is connected to a first terminal of the first transistor M1, and a second terminal thereof is connected to a first terminal of the second transistor M2. A first terminal of the third transistor M3 is connected to the first terminal of the first capacitor C1. A first terminal of the fourth transistor M4 is connected to a second terminal of the first capacitor C1. A first terminal of the second capacitor C2 is connected to a second terminal of the fourth transistor M4.

During an operation of the charge pump 10, when the first transistor M1 and the second transistor M2 are turned on and the third transistor M3 and the fourth transistor M4 are turned off, the first capacitor C1 is charged by the power supply VDD. When the first transistor M1 and the second transistor M2 are turned off and the third transistor M3 and the fourth transistor M4 are turned on, the second capacitor C2 is charged by the first capacitor C1. During the charging of the second capacitor C2 by the first capacitor C1, a voltage difference between the two capacitors gradually decreases until the voltage difference approaches zero, in which case the first capacitor C1 and the second capacitor C2 achieve voltage equalization, thereby completing the charging of the second capacitor C2 by the first capacitor C1. In an embodiment, an output voltage Vout of the second capacitor C2 is a negative voltage.

The overcurrent protection circuit 20 includes a current source Is and a fifth transistor M5. The current source Is is connected to the control circuit 30. The fifth transistor M5 is connected to the current source Is and the third transistor M3. The current source Is, the fifth transistor M5, and the third transistor M3 form a current mirror circuit. During the operation of the charge pump 10, if an unexpected short circuit occurs in the second capacitor C2, a current in the circuit increases, which causes the third transistor M3 and the fourth transistor M4 to be damaged. In an embodiment, the overcurrent protection circuit 20 may form the current mirror circuit through connection of the fifth transistor M5 to the third transistor M3. When a short circuit occurs in the second capacitor C2, a voltage at the first terminal of the first capacitor C1 increases, causing the third transistor M3 to enter a saturation region. In this case, the current is controlled by a power supply of the current source Is, to prevent the third transistor M3 and the fourth transistor M4 from being damaged due to an excessively large current flowing therethrough when the second capacitor C2 is short-circuited.

The control circuit 30 includes a first comparator CMP1 and a second comparator CMP2. The first comparator CMP1 has a first input terminal, a second input terminal, and an output terminal. The second comparator CMP2 has a first input terminal, a second input terminal, and an output terminal. The first input terminal of the first comparator CMP1 is connected to the first terminal of the first capacitor C1, and is configured to receive a voltage Vcp from the first terminal of the first capacitor C1 as an input. The second input terminal is configured to connect to a first reference voltage Vref1. The output terminal is configured to connect to the current source Is.

The second comparator CMP2 has a first input terminal, a second input terminal, and an output terminal. The second comparator CMP2 has a first input terminal, a second input terminal, and an output terminal. The first input terminal of the first comparator CMP1 is connected to the first terminal of the first capacitor C1, and is configured to receive the voltage Vcp from the first terminal of the first capacitor C1 as an input. The second input terminal is configured to connect to the second reference voltage Vref2. The output terminal is configured to connect to the current source Is. In an embodiment, the first reference voltage Vref1 is greater than the second reference voltage Vref2.

FIG. 4 schematically shows a saturation characteristic curve of a field-effect transistor. As shown in FIG. 4, in a normal operating mode, to achieve better efficiency of the charge pump 10, all switches (field-effect transistors M1-M4) of the charge pump 10 are operated in a linear region. For example, when a drain-source voltage Vds of a field-effect transistor is 0.2 V, if an operating current of 1 A is required, a gate-source voltage VGS needs to be increased from VGS2 to VGS3. However, if a short circuit occurs in the second capacitor C2 at this moment, a drain-source voltage Vds of the third transistor M3 significantly increases, causing the field-effect transistor to enter a saturation region. At the original gate-source voltage VGS3, a current in a circuit increases to be more than 4 A, which causes damages the field-effect transistor. Therefore, a driving voltage condition of the current mirror needs to be changed in time when a short circuit occurs in the second capacitor C2, so that the current in the circuit can be maintained in an operating current state in a normal operating mode when the second capacitor C2 is short-circuited.

As shown in FIG. 3, in this embodiment, when the charge pump 10 operates in the normal mode and the second capacitor C2 is charged by the first capacitor C1, the first terminal of the first comparator CMP1 and the first terminal of the second comparator CMP2 both receive the voltage Vcp of the first terminal of the first capacitor C1. The voltage Vcp of the first terminal of the first capacitor C1 is the voltage difference between the first capacitor C1 and the second capacitor C2. In an embodiment, the first reference voltage Vref1 is greater than the second reference voltage Vref2.

Since the voltage difference between the two capacitors is the largest at the beginning of charging, the voltage Vcp of the first terminal of the first capacitor C1 is greater than both the first reference voltage Vref1 and the second reference voltage Vref2, so that the first comparator CMP1 and the second comparator CMP2 both output a first level to control the current source Is to output a first current.

As the charging of the second capacitor C2 by the first capacitor C1 goes on, the voltage difference between the first capacitor C1 and the second capacitor C2 gradually decreases. When the voltage Vcp of the first terminal of the first capacitor C1 is less than the first reference voltage Vref1 and greater than the second reference voltage Vref2, the first comparator CMP1 outputs a second level, and the second comparator CMP2 outputs the first level. The current source Is outputs a corresponding second current based on the level conditions of the two comparators, where the second current is greater than the first current.

When the second capacitor C2 is charged to a full voltage by the first capacitor C1, the voltage difference between the first capacitor C1 and the second capacitor C2 approaches zero. In this case, the voltage Vcp of the first terminal of the first capacitor C1 is less than both the first reference voltage Vref1 and the second reference voltage Vref2, so that the first comparator CMP1 and the second comparator CMP2 both output the second level. The current source Is controls, based on the level conditions outputted by the two comparators, the current source to output a third current. The third current is greater than the second current.

During the charging of the second capacitor C2 by the first capacitor C1, if a short circuit occurs in the second capacitor C2, the voltage difference between the first capacitor C1 and the second capacitor C2 increases. Because the second capacitor C2 is short-circuited, the voltage Vcp of the first terminal of the first capacitor increases to be greater than both the first reference voltage Vref1 and the second reference voltage Vref2, so that the first comparator CMP1 and the second comparator CMP2 both output the first level to control the current source Is to output the first current. Thus, the driving voltage condition of the current mirror can be changed in real time, so that the current in the circuit can be maintained in the operating current state in the normal operating mode when the second capacitor C2 is short-circuited.

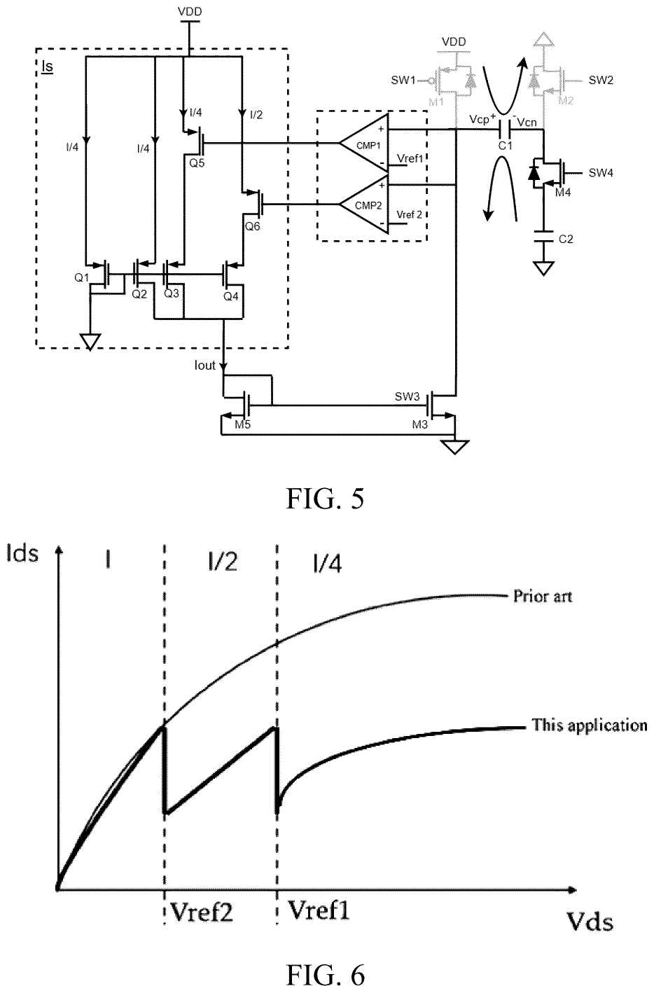

FIG. 5 schematically shows an overcurrent protection circuit used with a charge pump in accordance with an embodiment of the present disclosure. The current source Is includes a first power transistor Q1, a second power transistor Q2, a third power transistor Q3, a fourth power transistor Q4, a fifth power transistor Q5, and a sixth power transistor Q6. In an embodiment, the power transistors Q1-Q6 are P-type metal-oxide-semiconductor field-effect transistors (MOSFET).

A gate of the first power transistor Q1 is connected to a drain thereof. Gates of the first power transistor Q1, the second power transistor Q2, the third power transistor Q3, and the fourth power transistor Q4 are connected to mirror a current of the first power transistor Q1. A drain of the fifth power transistor Q5 is connected to a source of the third power transistor Q3 to function as a switch. A drain of the sixth power transistor Q6 is connected to a source of the fourth power transistor Q4 to function as a switch. An output terminal of the first comparator CMP1 is connected to the fifth power transistor Q5. An output terminal of the second comparator CMP2 is connected to the sixth power transistor Q6. Drains of the second power transistor Q2, the third power transistor Q3, and the fourth power transistor Q4 are connected to combine currents and form an output current Iout.

In an embodiment, a width-to-length ratio of the first power transistor Q1, the second power transistor Q2, and the third power transistor Q3 may be designed as 1:1. A width-to-length ratio of the first power transistor Q1 and the fourth power transistor Q4 may be designed as 1:2. Thus, when the current of the first power transistor Q1 is I/4, the current of the second power transistor Q2 is I/4, the current of the third power transistor Q3 is I/4, and the current of the fourth power transistor Q4 is I/2.

In an embodiment, the first terminal of the first comparator CMP1 is an in-phase input terminal (+) configured to receive the voltage Vcp of the first terminal of the first capacitor C1 as an input, and the second terminal thereof is an out-phase input terminal (−) configured to input the first reference voltage Vref1 as an input. The first terminal of the second comparator CMP2 is an in-phase input terminal (+) configured to receive the voltage Vcp of the first terminal of the first capacitor C1 as an input, and the second terminal thereof is an out-phase input terminal (−) configured to receive the second reference voltage Vref2 as an input. In an embodiment, the first reference voltage Vref1 is greater than the second reference voltage Vref2.

When the voltage Vcp of the first terminal of the first capacitor C1 is greater than both the first reference voltage Vref1 and the second reference voltage Vref2, the first comparator CMP1 and the second comparator CMP2 both output a high level, so that the fifth power transistor Q5 and the sixth power transistor Q6 are both turned off. The output current Iout is I/4.

When the voltage Vcp of the first terminal of the first capacitor C1 is less than the first reference voltage Vref1 and greater than the second reference voltage Vref2, the first comparator CMP1 outputs a low level, and the second comparator CMP2 outputs a high level, so that the fifth power transistor Q5 is turned on, and the sixth power transistor Q6 is turned off. The output current Iout is I/2.

When the voltage Vcp of the first terminal of the first capacitor C1 is less than both the first reference voltage Vref1 and the second reference voltage Vref2, the first comparator CMP1 and the second comparator CMP2 both output a low level, so that the fifth power transistor Q5 and the sixth power transistor Q6 are both turned on. The output current Iout is I.

When the second capacitor C2 is short-circuited, the voltage Vcp of the first terminal of the first capacitor C1 is greater than both the first reference voltage Vref1 and the second reference voltage Vref2, the first comparator CMP1 and the second comparator CMP2 both output a high level, so that the fifth power transistor Q5 and the sixth power transistor Q6 are both turned off. The output current Iout is I/4.

Compared to the saturation characteristic curve of the prior art shown in FIG. 4, FIG. 6 schematically shows a voltage-current characteristic curve in accordance with an embodiment of the present disclosure. When a short circuit occurs in the second capacitor C2, a drain-source voltage Vds of the third transistor M3 increases. In this case, the control circuit 30 can control the output current of the current source Is in time to adjust a driving voltage of the third transistor M3, to prevent increase of the current in the circuit, thereby preventing damage to the third transistor M3 and the fourth transistor M4.

While various embodiments have been described above to illustrate the charge pump, the overcurrent protection circuit and the control method thereof, it should be understood that they have been presented by way of example only, and not limitation. Rather, the scope of the present disclosure is defined by the following claims and includes combinations and sub-combinations of the various features described above, as well as variations and modifications thereof, which would occur to persons skilled in the art upon reading the foregoing description.

What is claimed is:

1. A charge pump, comprising:
a first capacitor, having a first terminal and a second terminal;
a current controlling transistor, having a first terminal, a second terminal and a control terminal, wherein the first terminal is coupled to the first terminal of the first capacitor, and the second terminal is coupled to a ground reference;
an overcurrent protection circuit, comprising a current source and a bias transistor, wherein:
the current source has a first terminal, a second terminal and a control terminal, wherein the first terminal is coupled to a power supply;
the bias transistor has a first terminal, a second terminal and a control terminal, wherein the first terminal is coupled to the second terminal of the current source, the second terminal is coupled to the ground reference, and the control terminal is coupled to both the first terminal of the bias transistor and the control terminal of the current controlling transistor.

2. The charge pump of claim 1, further comprising:
a first transistor, having a first terminal, a second terminal and a control terminal, wherein the first terminal is coupled to the power supply, the second terminal is coupled to the first terminal of the first capacitor;
a second transistor, having a first terminal, a second terminal and a control terminal, wherein the first terminal is coupled to the ground reference, and the second terminal is coupled to the second terminal of the first capacitor;
a fourth transistor, having a first terminal, a second terminal and a control terminal, wherein the first terminal is coupled to the second terminal of the first capacitor, and the second terminal is coupled to an output terminal of the charge pump.

3. The charge pump of claim 2, wherein the first transistor and the second transistor are turned on and off simultaneously, and the current controlling transistor and the fourth transistor are turned on and off simultaneously.

4. The charge pump of claim 2, further comprising:
a second capacitor, having a first terminal and a second terminal, wherein the first terminal is coupled to the output terminal of the charge pump, and the second terminal is coupled to the ground reference.

5. The charge pump of claim 4, wherein the voltage at the first terminal of the first capacitor is larger than a first reference voltage when the second capacitor is shorted.

6. The charge pump of claim 1, further comprising:
a control circuit having an input terminal and an output terminal, wherein the input terminal is coupled to the first terminal of the first capacitor, and the output terminal is coupled to the control terminal of the current source to provide a current controlling signal based on a voltage at the first terminal of the first capacitor.

7. The charge pump of claim 6, wherein the control circuit comprises:
a first comparator, having a first input terminal, a second input terminal and an output terminal, wherein the first input terminal is coupled to the first terminal of the first capacitor, the second input terminal is configured to receive a first reference voltage, and an output terminal is configured to provide a first comparison signal; and
a second comparator, having a first input terminal, a second input terminal and an output terminal, wherein the first input terminal is coupled to the first terminal of the first capacitor, the second input terminal is configured to receive a second reference voltage, and an output terminal is configured to provide a second comparison signal;
wherein the current controlling signal comprises the first comparison signal and the second comparison signal.

8. The charge pump of claim 7, wherein:
when the voltage at the first terminal of the first capacitor is larger than both the first reference voltage and the second reference voltage, the current source provides a first current;
when the voltage at the first terminal of the first capacitor is smaller than the first reference voltage but is larger than the second reference voltage, the current source provides a second current; and
when the voltage at the first terminal of the first capacitor is smaller than both the first reference voltage and the second reference voltage, the current source provides a third current;
wherein the first current is smaller than the second current, the second current is smaller than the third current, and the first reference voltage is larger than the second reference voltage.

9. The charge pump of claim 8, wherein the third current is twice the second current, and the second current is twice the first current.

10. The charge pump of claim 7, wherein the current source comprises:
a first power transistor, having a source terminal, a drain terminal and a gate terminal, wherein the source terminal is coupled to the power supply, the drain terminal is coupled to the ground reference, and the gate terminal is coupled to the drain terminal;
a second power transistor, having a source terminal, a drain terminal and a gate terminal, wherein the source terminal is coupled to the power supply, the drain terminal is coupled to the second terminal of the current source, and the gate terminal is coupled to the gate terminal of the first power transistor;
a third power transistor, having a source terminal, a drain terminal and a gate terminal, wherein the drain terminal is coupled to the second terminal of the current source, and the gate terminal is coupled to the gate terminal of the first power transistor;
a fourth power transistor, having a source terminal, a drain terminal and a gate terminal, wherein the drain terminal is coupled to the second terminal of the current source, and the gate terminal is coupled to the gate terminal of the first power transistor;
a fifth power transistor, having a source terminal, a drain terminal and a gate terminal, wherein the source terminal is coupled to the power supply, the drain terminal is coupled to the source terminal of the third power transistor, and the gate terminal is configured to receive the first comparison signal; and
a sixth power transistor, having a source terminal, a drain terminal and a gate terminal, wherein the source terminal is coupled to the power supply, the drain terminal is coupled to the source terminal of the fourth power transistor, and the gate terminal is configured to receive the second comparison signal.

11. An overcurrent protection circuit used with a charge pump, wherein the charge pump comprises a first capacitor and a current controlling transistor coupled between a first terminal of the capacitor and a ground reference, the overcurrent protection circuit comprising:
a current source, having a first terminal, a second terminal and a control terminal, wherein the first terminal is coupled to a power supply, and the control terminal is in response to a voltage at the terminal of the capacitor;
a bias transistor having a first terminal, a second terminal and a control terminal, wherein the first terminal is coupled to the second terminal of the current source, the second terminal is coupled to the ground reference, and the control terminal is coupled to both the first terminal of the bias transistor and a control terminal of the current controlling transistor.

12. The overcurrent protection circuit of claim 11, further comprising:
a control circuit having an input terminal and an output terminal, wherein the input terminal is coupled to the first terminal of the first capacitor, and the output terminal is coupled to the control terminal of the current source to provide a current controlling signal based on a voltage at the first terminal of the first capacitor.

13. The overcurrent protection circuit of claim 12, wherein the control circuit comprises:
a first comparator, having a first input terminal, a second input terminal and an output terminal, wherein the first input terminal is coupled to the first terminal of the first capacitor, the second input terminal is configured to receive a first reference voltage, and an output terminal is configured to provide a first comparison signal; and
a second comparator, having a first input terminal, a second input terminal and an output terminal, wherein the first input terminal is coupled to the first terminal of the first capacitor, the second input terminal is configured to receive a second reference voltage, and an output terminal is configured to provide a second comparison signal;
wherein the current controlling signal comprises the first comparison signal and the second comparison signal.

14. The overcurrent protection circuit of claim 13, wherein:
when the voltage at the first terminal of the first capacitor is larger than both the first reference voltage and the second reference voltage, the current source provides a first current;
when the voltage at the first terminal of the first capacitor is smaller than the first reference voltage but is larger than the second reference voltage, the current source provides a second current; and
when the voltage at the first terminal of the first capacitor is smaller than both the first reference voltage and the second reference voltage, the current source provides a third current;
wherein the first current is smaller than the second current, the second current is smaller than the third current, and the first reference voltage is larger than the second reference voltage.

15. The overcurrent protection circuit of claim 14, wherein the third current is twice the second current, and the second current is twice the first current.

16. The overcurrent protection circuit of claim 13, wherein the current source comprises:
a first power transistor, having a source terminal, a drain terminal and a gate terminal, wherein the source terminal is coupled to the power supply, the drain terminal is coupled to the ground reference, and the gate terminal is coupled to the drain terminal;
a second power transistor, having a source terminal, a drain terminal and a gate terminal, wherein the source terminal is coupled to the power supply, the drain terminal is coupled to the second terminal of the current source, and the gate terminal is coupled to the gate terminal of the first power transistor;
a third power transistor, having a source terminal, a drain terminal and a gate terminal, wherein the drain terminal is coupled to the second terminal of the current source, and the gate terminal is coupled to the gate terminal of the first power transistor;
a fourth power transistor, having a source terminal, a drain terminal and a gate terminal, wherein the drain terminal is coupled to the second terminal of the current source, and the gate terminal is coupled to the gate terminal of the first power transistor;
a fifth power transistor, having a source terminal, a drain terminal and a gate terminal, wherein the source terminal is coupled to the power supply, the drain terminal is coupled to the source terminal of the third power transistor, and the gate terminal is configured to receive the first comparison signal; and
a sixth power transistor, having a source terminal, a drain terminal and a gate terminal, wherein the source terminal is coupled to the power supply, the drain terminal is coupled to the source terminal of the fourth power transistor, and the gate terminal is configured to receive the second comparison signal.

17. A control method of an overcurrent protection circuit used with a charge pump, comprising:
generating a current controlling signal based on a voltage at a terminal of a capacitor of the charge pump;
generating a current flowing through a bias transistor based on the current controlling signal;
mirroring the current flowing through the bias transistor to a current controlling transistor coupled between the terminal of the capacitor and a ground reference.

18. The control method of claim 17, wherein generating a current controlling signal based on a voltage at a terminal of a capacitor of the charge pump comprises:
comparing the voltage at the terminal of the capacitor to a first reference voltage to generate a first comparison signal; and
comparing the voltage at the terminal of the capacitor to a second reference voltage to generate a second comparison signal;
wherein the current controlling signal comprises the first comparison signal and the second comparison signal, and wherein the first reference signal is larger than the second reference signal.

19. The control method of claim 18, wherein:
when the voltage at the first terminal of the first capacitor is larger than both the first reference voltage and the second reference voltage, the current provided by the current source has a first value;
when the voltage at the first terminal of the first capacitor is smaller than the first reference voltage but is larger than the second reference voltage, the current provided by the current source has a second value; and
when the voltage at the first terminal of the first capacitor is smaller than both the first reference voltage and the second reference voltage, the current provided by the current source has a third value;
wherein the first value is smaller than the second value, and the second value is smaller than the third value.

20. The control method of claim 19, wherein the third value is twice the second value, and the second value is twice the first value.
